(19) United States
(12) Patent Application Publication
(10) Pub. No.: US 2016/0132205 A1
(43) Pub. Date: May 12, 2016

(54) SYSTEM AND METHOD FOR LINKING APPLICATIONS

(71) Applicant: EBAY INC., San Jose, CA (US)

(72) Inventors: Arun Ramakrishnan, Chennai (IN); Jagadeesh Jeeva, Chennai (IN); Vijaya Vigneshwara Moorthi Subramanian, Chengalpattu (IN); Vijay Rai, Karnataka (IN)

(21) Appl. No.: 14/536,072

(22) Filed: Nov. 7, 2014

(51) Int. Cl. G06F 3/0488; G06F 3/0481; G06F 3/0486

(52) U.S. Cl. CPC G06F 3/0488; G06F 3/0486; G06F 3/04817

(57) ABSTRACT

A system and method includes a device and a processor. In some embodiments the processor is operable to display a first representation for a first application at a first location on the touchscreen display and a second representation for a second application. In some embodiments, the device detects a contact on a touchscreen display at the first location. In some embodiments, the device detects a gesture on the touchscreen display and links the first application with the second application. In some embodiments the device links the first application with the second application when the gesture conforms to a predetermined gesture.

### BACKGROUND

1. Field of the Disclosure

The present disclosure generally relates to user interfaces and more particularly to linking and/or setting up interoperability of applications on a device using gestures.

2. Related Art

Many devices have third party applications installed on the device by the user to perform a particular activity. For example, a user may have an application for reading books, playing games, shopping, gambling, making payments, and so forth. Generally each application is self-contained and does not interact with any other application. For example, there may be a merchant application that displays products for sale and a separate application that allows a user to send money to merchants. However, these applications generally will not interact. A user who wishes to buy a product from a merchant using a merchant application would either have to insert payment information into the merchant application and/or go into the payment application to send payment to the merchant. This can be cumbersome, inefficient, and duplicative. Thus a system and method for users to easily enable interoperability between applications would be desirable.

### BRIEF DESCRIPTION OF THE FIGURES

FIG. 1 is a block diagram of an exemplary computing system that may be used for linking applications by performing gestures.

FIG. 2 is a flow diagram of an exemplary process for initiating a linkage between applications using gestures.

FIG. 2A is a flow diagram of an exemplary process for initiating a linkage between applications using audio signals.

FIG. 3 is an exemplary GUI display on a user device that a user may use to perform a linking action to link applications.

FIGS. 4-5 illustrate the GUI display of FIG. 3 at various points during the performance of an exemplary linking action.

FIG. 6 illustrates an exemplary user input condition for conducting a linking action on the GUI display of the user device of FIG. 3.

FIG. 7 is a flow diagram of an exemplary process for linking applications.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Systems and methods which may be used for linking applications are disclosed. Often times, user devices have multiple applications created by several entities. These applications generally are unable to interact with each other. Thus, if a user wanted to enter information from one application into another application, the user would need to open both applications and conduct a cut and paste operation. In some cases users will need to memorize information from one application for use in another application. Users may find this to be a very cumbersome process. Therefore, it would be useful if a system and method were developed to allow application interactions. For example, instead of having to enter in payment information to buy a movie from a movie application, the user may be able to link a payment application to the movie application. Once the two applications are linked, the movie application may automatically retrieve payment information from the payment application on behalf of the user.

As another example, instead of having to cut and paste an address from an address application to a map application, a user may be able to link or have the address book push an address to the map application. It would also be beneficial if the system and method for linking applications were made to be user friendly and intuitive.

Some of the embodiments discussed herein disclose a device comprising a touchscreen display and a processor. In some embodiments the processor is configured to display a first icon for a first application at a first location on the touchscreen display and a second icon for a second application at a second location on the touchscreen display; detect a contact on the touchscreen display at the first location; detect a gesture on the touchscreen display; and link the first application with the second application when the gesture conforms with a predetermined gesture.

Some of the embodiments disclosed herein disclose a method of linking a first application and a second application on a device, the device including a touchscreen display. The method may include displaying a first icon for a first application at a first location on the touchscreen display and a second icon for a second application at a second location on the touchscreen display; detecting a contact on the touchscreen display at the first location; detecting a gesture on the touchscreen display that conforms with a predetermined gesture; and linking the first application with the second application in response to detecting the gesture on the touchscreen display.

Some of the embodiments disclosed herein disclose a machine readable memory storing instructions, which when executed by a device with a touchscreen causes the device to perform, displaying a first icon for a first application at a first location on the touchscreen display and a second icon for a second application at a second location on the touchscreen display; detecting a contact on the touchscreen display at the first location; detecting a gesture on the touchscreen display that conforms with a predetermined gesture; and linking the first application with the second application in response to detecting the gesture on the touchscreen display.

In some embodiments, an application on a device with a touch-sensitive display may be linked with and/or coupled to another application via gestures performed on the touch-sensitive display. As used herein, a gesture is a motion of the object/appendage. The gesture may be performed by making contact with the touch screen and/or motion of an I/O device, such as a mouse and/or other pointing device. In some embodiments, a cursor may be used to perform the gestures. In some embodiments, a camera, motion detector, and/or other devices may be used to detect gestures.

In some embodiments, a first application on a device may have an application programming interface (API) which allows a second application on the device to interact and/or communicate with the first application. The interaction between the first application and second application may be initiated by the selection and/or gestures performed with and/or on icons of a graphical user interface shown on a display. The icons may be related to the first application and second application.

In some examples, the first application may interact with the second application when an icon for the first application is dragged and dropped on top of the second application using a cursor controlled by an input and/or output device, such as a mouse or other pointing device, and/or a gesture performed on a touch-sensitive display.

In some examples, the first application and second application may interact with each other when a user touches a touch screen display to cause an image and/or icon related to the first application to move on top of an image and/or icon related to the second application.

In some examples, the first application and second application may interact with each other when a user simultaneously touches two locations on a touch-screen display, wherein the two locations are the locations of a first and second icon related to the first and second application displayed by a GUI on a touch-screen display.

In some embodiments, a gesture for causing applications to interact with each other may be performed for a predetermined amount of time. For example, a user may drag an icon related to a first application near and/or on top of a second application for initiating application interaction. The GUI may display a status bar, a countdown, and/or other indication that indicates the length of time a gesture should be performed to cause an interaction between the applications. In some examples, a device may display an indication and/or otherwise communicate to a user that a gesture successfully caused the linkage of applications and/or whether an error occurred.

In some embodiments, specific gesture patterns may be used to initiate interactions between a first application and a second application. In some examples, the pattern may be application specific. In some examples, a pattern specifically for one application may be conducted while within a GUI provided by a second application. For example, while a user is using a product purchasing application, a user may draw a P on the touch-sensitive display causing a payment application to push information to the product purchasing application.

In some embodiments, the gesture patterns may be drawn by dragging an icon in a graphical user interface to create a pattern, the completion of the pattern causing the interaction between a first application and a second application. For example, dragging an icon for a first application in a circle around a second application may cause the interaction between the first application and the second application. In some examples, when an icon for the first application is selected and/or dragged, icons for other applications which contain plugins and/or APIs compatible with the first application may display an indicator that the other application can interact or be linked with the first application.

In some examples, the indication may be a traceable gesture that displays the completion status of a gesture as the user conducts the gesture. For example, a partially transparent circle may appear around an icon for applications with APIs that link with a first application. As the first application icon is dragged in a manner that traces the partially transparent circle, portions of the circle may become opaque indicating the progress of the gesture.

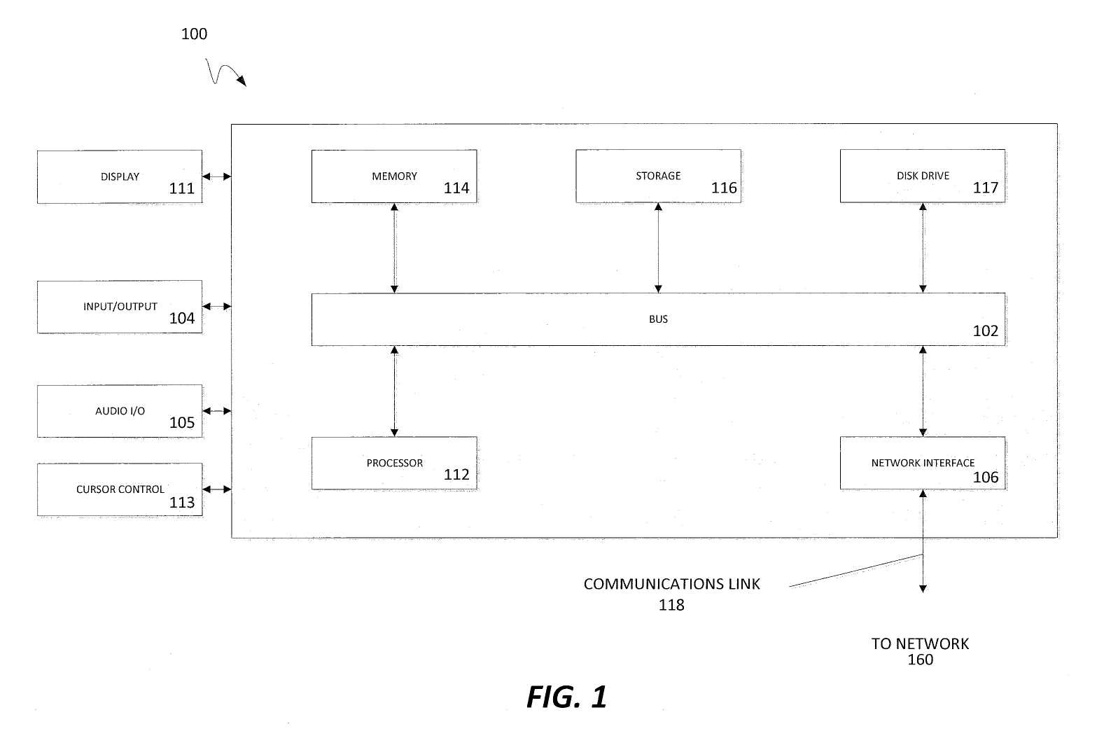

FIG. 1 illustrates an exemplary computer system 100 that may be used for linking applications by performing gestures. It should be appreciated that each of the methods and systems described herein may be implemented by one or more of computer system 100.

In various implementations, a device that includes computer system 100 may comprise a personal computing device (e.g., a smart or mobile phone, a computing tablet, a personal computer, laptop, wearable device, PDA, Bluetooth device, key FOB, badge, etc.).

The computer system 100 may be any portable electronic device, including but not limited to a handheld computer, a tablet computer, a mobile phone, a media player, a personal digital assistant (PDA), or the like, including a combination of two or more of these items. It should be appreciated that the computer system 100 is only one example of a computer system, and that computer system 100 may have more or fewer components than shown, or a different configuration of components. The various components shown in FIG. 1 may be implemented in hardware, software or a combination of both hardware and software, including one or more signal processing and/or application specific integrated circuits.

Computer system 100 may include a bus 102 or other communication mechanisms for communicating information data, signals, and information between various components of computer system 100. Components include an input/output (I/O) component 104 that processes a user action, such as selecting keys from a keypad/keyboard, selecting one or more buttons, links, actuatable elements, etc., and sends a corresponding signal to bus 102. I/O component 104 may also include an output component, such as a display 111 and a cursor control device 113 (such as a keyboard, touch pad, keypad, mouse, pointing device, touchscreen/touch sensitive display, etc.).

In some embodiments a touchscreen may provide both an output interface and an input interface between the computer system 100 and a user. The touchscreen may have a controller that is in communication with processor 112 that receives/sends electrical signals from/to a touchscreen. The touchscreen may display visual output to a user. The visual output may include text, graphics, video, and any combination thereof. Some or all of the visual output may correspond to user-interface objects, further details of which are described below.

The touchscreen may also accept input from a user based on haptic and/or tactile contact. The touchscreen may form a touch-sensitive surface that accepts user input. The touchscreen may detect contact (and any movement or break of the contact) on the touchscreen and convert the detected contact into interaction with user-interface objects, such as one or more soft keys, icons, virtual buttons, images, and/or the like that are displayed on the touchscreen. In an exemplary embodiment, a point of contact between the touchscreen and the user corresponds to one or more digits of the user. The touchscreen may use LCD (liquid crystal display) technology, LPD (light emitting polymer display) technology, and/or other display technologies. The touchscreen may detect contact and any movement or break thereof using any of a plurality of touch sensitive technologies, including but not limited to capacitive, resistive, infrared, and surface acoustic wave technologies, as well as other proximity sensor arrays or other elements for determining one or more points of contact with the touchscreen. The touch-sensitive display may be a multi-touch display which has the capability to recognize the presence of more than one point of contact. A user may make contact with the touchscreen using any suitable object or appendage, such as a stylus, finger, and so forth.

In some embodiments, computer system 100 may include a touchpad for activating or deactivating particular functions. In some embodiments, the touchpad is a touch-sensitive area of the device that, unlike the touchscreen, does not display visual output. The touchpad may be a touch-sensitive surface that is separate from display 111 or an extension of the touch-sensitive surface formed by a touchscreen.

In some embodiments, computer system 100 may include a camera, a motion detection device, and/or the like. The motion detection device and/or camera may be configured to detect gestures that are performed by a user. In some embodiments, computer system 100 may have an I/O device that may display a virtual touchpad and/or virtual reality objects that a user may interact with which the I/O device may detect and translate into device commands.

In some embodiments, computer system 100 may have an audio input/output (I/O) component 105 which may allow a user to use voice for inputting information to computer system 100 by converting audio signals. Audio I/O component 105 may also allow for computer system 100 to generate audio waves which a user may be able to hear. In some examples audio I/O component 105 may include a microphone and/or a speaker.

Computer system 100 may have a transceiver or network interface 106 that transmits and receives signals between computer system 100 and other devices, such as another user device, server, websites, and/or the like via a network. In various embodiments, such as for many cellular telephone and other mobile device embodiments, this transmission may be wireless, although other transmission mediums and methods may also be suitable. A processor 112, which may be a microprocessor, micro-controller, digital signal processor (DSP), or other processing component, processes these various signals, such as for display on computer system 100 or transmission to other devices over a network 160 via a communication link 118. Again, communication link 118 may be a wireless communication in some embodiments. Processor 112 may also control transmission of information, such as cookies, IP addresses, and/or the like to other devices.

Components of computer system 100 also include a system memory component 114 (e.g., RAM), a static storage component 116 (e.g., ROM, EPROM, EEPROM, flash memory), and/or a disk drive 117. Computer system 100 performs specific operations by processor 112 and other components by executing one or more sequences of instructions contained in system memory component 114 and/or static storage component 116. Logic may be encoded in a computer readable medium, which may refer to any medium that participates in providing instructions to processor 112 for execution. Such a medium may take many forms, including but not limited to, non-volatile media, volatile media, and transmission media. In various implementations, non-volatile media includes optical or magnetic disks, volatile media includes dynamic memory, such as system memory component 114, and transmission media includes coaxial cables, copper wire, and fiber optics, including wires that comprise bus 102. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

Computer system 100 generally may provide one or more client programs such as system programs and application programs to perform various computing and/or communications operations. Exemplary system programs may include, without limitation, an operating system (e.g., MICROSOFT® OS, UNIX® OS, LINUX® OS, Symbian OS™ Embedix OS, Binary Run-time Environment for Wireless (BREW) OS, JavaOS, a Wireless Application Protocol (WAP) OS, Android™, Apple iPhone™ operating system, iOS™, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of the client programs may display various graphical user interfaces (GUIs) to present information to and/or interact with a user.

In various embodiments of the present disclosure, execution of instruction sequences to practice the present disclosure may be performed by computer system 100. In various other embodiments of the present disclosure, a plurality of computer systems 100 coupled by communication link 118 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the steps described herein.

A computer system may transmit and receive messages, data, information and instructions, including one or more programs (i.e., application code) through a communication link, such as communications link 118, and a communication interface, such as network interface 106. Received program code may be executed by processor 112 as received and/or stored in system memory component 114 and/or static storage component 116 for execution later.

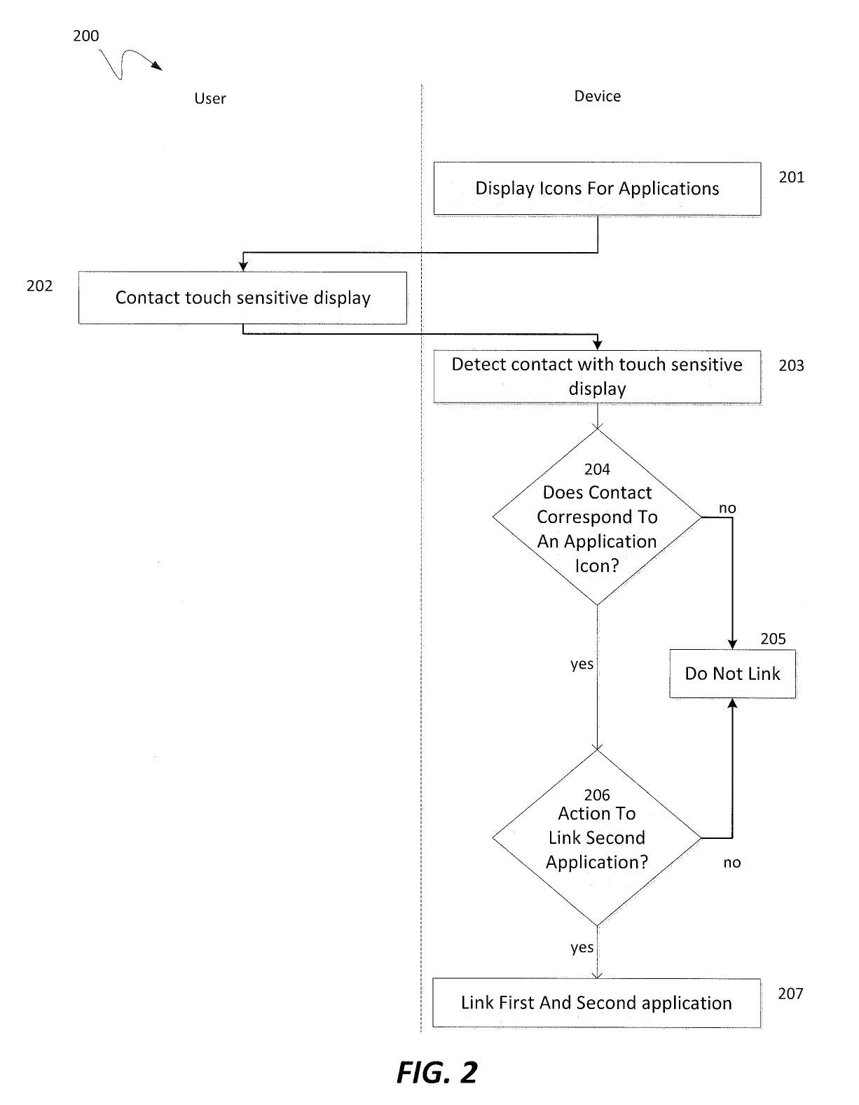

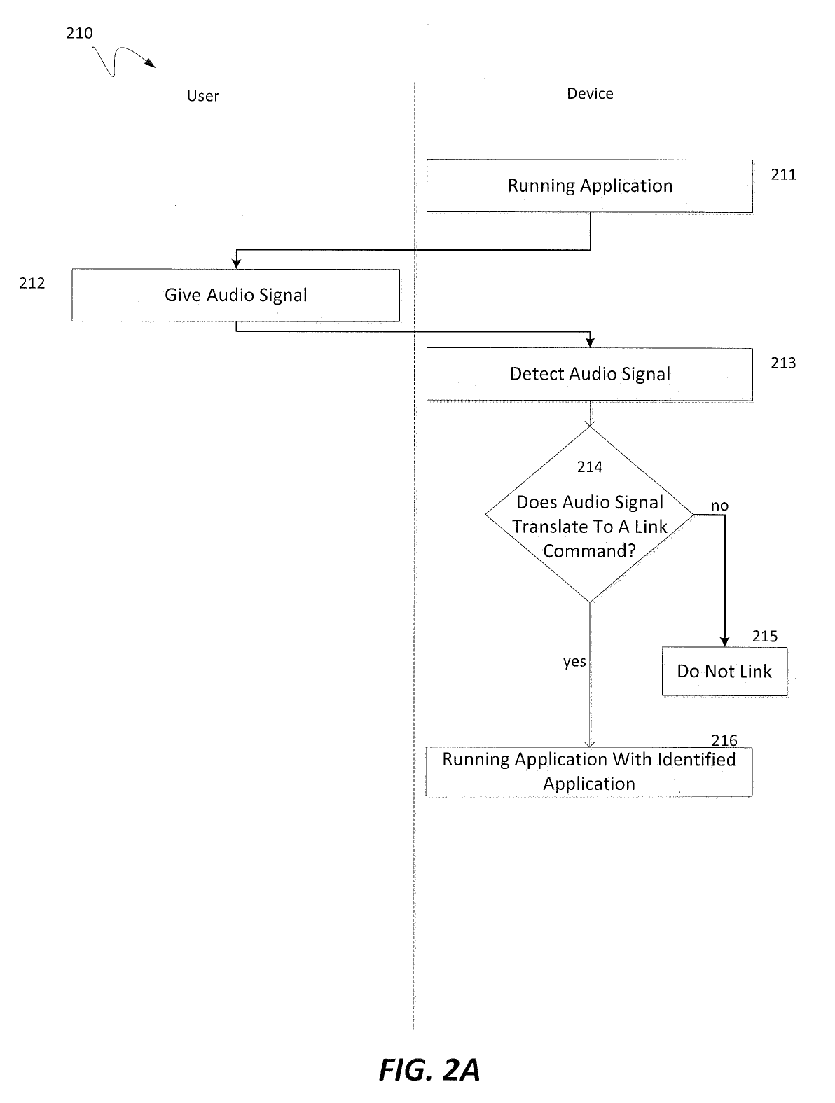

FIG. 2 is a flow diagram illustrating a process 200 for linking two applications on a device, such as computer system 100 of FIG. 1, when a user performs a linking action according to some embodiments. Process 200 will be illustrated using a touch screen, but one of ordinary skill would understand that any suitable GUI and pointing device may be used to achieve similar results. As used herein, linking two applications may include linking functionality between two applications, enabling one or both applications to execute and/or call one or more functions of the other application, allowing the transfer of data between the two applications, and/or the like. The process of linking two applications may be, as perceived by the user, instantaneous, near-instantaneous, gradual, and/or at any suitable rate. The progression of the process may be either controlled automatically by the device independent of a user once the process is activated or controlled by the user. While process 200 described below includes a number of operations that appear to occur in a specific order, it should be apparent that these processes may include more or fewer operations, which may be executed serially or in parallel (e.g., using parallel processors and/or a multi-threading environment), combined, and/or in different orders.

At 201, a device may display several user-interface objects on a display. The user-interface objects may be objects that make up the user interface of the device and may include, without limitation, icons, text, images, soft keys, virtual buttons, pull-down menus, radio buttons, check boxes, selectable lists, and so forth. The displayed user-interface objects may include non-interactive objects that convey information or contribute to the look and feel of the user interface, interactive objects with which the user may interact, or any combination thereof.

In some embodiments, the user-interface objects may be displayed on a home screen. A home screen may be a main screen for a GUI of an operating system. The home screen may allow a user to select, access, execute, and/or initiate an application. The home screen may display, on the touchscreen, user-interface objects corresponding to one or more functions of the device and/or information that may be of interest to the user. The user may interact with the user-interface objects by making contact with the touchscreen at one or more touchscreen locations corresponding to the interactive objects with which the user wishes to interact. The device may detect a user contact and may respond to the detected contact by performing the operation(s) corresponding to the interaction with the interactive object(s). In some embodiments, some of the user-interface objects may be representations of an application, such as an icon which display an image and/or text unique to a related application. The image may aid a user in distinguishing between icons for different applications. In some embodiments, the representation of an application may be a tactile object created that provides a unique touch sensation when touched, such as increased roughness, physical patterns like brail, ultrasonic vibration, and/or the like.

In some embodiments, the device may display the icons in a two dimensional GUI and/or a three dimensional GUI. The device may have a peripheral, such as a mouse or other pointing device, which allows the user to control a virtual pointer in the GUI. For example, the user may be able to move the virtual pointer in the GUI by moving the peripheral. The peripheral may have buttons that, when actuated, allow the user to select, control, and/or otherwise interact with objects displayed in the GUI (e.g. an icon for an application). For example, a user may select an icon by controlling the peripheral to move the virtual pointer over the icon and actuating a physical button on the peripheral.

In some embodiments, the device may have a motion detection device. The device may detect gestures performed by the user by detecting the motions of the user's hand. In some embodiments, the device may have an accelerometer and/or a gyroscope to detect gestures made with the device. In some embodiments, the motion detection device may be a camera that optically detects motion of an object, such as a hand, a stylus, and/or other objects. One of ordinary skill in the art would recognize the many different devices that may be used for motion detection, all of which are contemplated herein.

In some embodiments, the device may have a touchscreen. The device may display the icons as part of a GUI on the touchscreen. A user may use a finger or another object, such as a stylus, which may act as a physical pointer for the device. For example, the touchscreen may have a surface that maps points on the physical surface to points on a virtual surface of the GUI. A user may, by touching the surface of the touchscreen (with a finger or another object, such as a stylus), may in turn select, actuate, and/or otherwise interact with an object that is located on or near a point on the virtual surface that is mapped to the location that the user touched on the physical surface of the touchscreen. To avoid unnecessary repetition, process 200 is described with the use of a touchscreen; however, one of ordinary skill in the art would recognize that process 200 may be implemented using another peripheral, such as a mouse controlling a virtual pointer, a microphone detecting voice commands, a motion detection device detecting gestures without contact and/or the like.

At 202, the user may initiate contact with the touchscreen, e.g., touch the touchscreen. For convenience of explanation, contact on the touchscreen in the process 200 and in other embodiments described below will be described as performed by the user using at least one hand using one or more fingers. However, it should be appreciated that the contact may be made using any suitable object or appendage, such as a stylus, finger, etc. The contact may include one or more taps on the touchscreen, maintaining continuous contact with the touchscreen, movement of the point of contact while maintaining continuous contact, a breaking of the contact, and/or any combination thereof.

At 203, the device detects contact on the touchscreen. In some examples, the contact may be detected using any suitable touchscreen technology, such as capacitive, resistive, infrared, surface acoustic wave, etc. At 204, the device determines whether the point of contact on the touchscreen maps to a point on a GUI where there is an application icon. If the contact location does not map to a location on the GUI where there is an application icon, then process 200 does not initiate the linking of applications and returns to 203. For example, a user may accidently touch a location that is between two icons, which would not initiate the linking of applications.

If the point of contact on the touchscreen does map to a location on a GUI where there is an application icon, the device may, at 206, check for one or more predetermined combination of actions and/or gestures by the user to link one application with another. The action may be one or more predefined gestures performed on the touchscreen that may be combined with one or more interrupted and/or uninterrupted contacts with the touchscreen. As used herein, a gesture is a motion of the object/appendage. In some embodiments, the predetermined gestures and or actions may be user defined and/or user specific.

In some embodiments, the device may display visual cues that hint, remind, and/or instruct a user of the predetermined gestures and/or actions that, when performed, cause the device to link two applications. In some embodiments, the device may display visual cues that indicate which application and/or applications are linkable. The visual cues may be textual, graphical or any combination thereof. In some embodiments, the visual cues are displayed upon the occurrence of particular events and/or user inputs, such as when a user initiates a portion of a linking action. In some examples, the device may display the visual cues when the user touches the touchscreen continuously for a predetermined length of time, such as three seconds. In some examples, the device may display visual cues that display the completion progress of a gesture for linking applications, such as a status bar.

If the user performed action matches and/or conforms to a predetermined action(s), then the first and second applications may become linked at 207. If, on the other hand, the actions do not match, such as an incomplete action and/or unrelated action, the device may not initiate linking of the applications at 205. The linking between applications may be permanent, temporary, and/or linked until a user ends the linkage.

In some embodiments, the linking action may be between an application and another software element. In some examples, the device may display images of a purchasable product as an advertisement icon and/or an advertisement image. A user may conduct an action indicating the linkage of an application, such as a payment application, with the advertising icon and/or advertisement image. The user action may then link the payment application with the application displaying the advertising icon and/or image to purchase a product.

In some examples, the device may display product information, such as a product image, for a product being advertised on a second device, such as a television. The device may retrieve the product information by receiving a QR code, Bluetooth, and/or other wireless communications from the second device and/or a third party device. The communications may cause the device to display product information, and the ability to purchase the product using one or more payment applications. The user may conduct a linking action to link an application with the advertised product, to purchase the product, save the product information, and/or the like.

In some embodiments, the device may begin the process of linking applications upon detection of a partial completion of one or more actions and/or gestures on the touchscreen and aborts the linking as soon as the device determines that the contact does not correspond to a linking action or is a failed/aborted linking action.

In some examples, if the link action includes a predefined gesture, the device may begin the process of linking two applications before the completion of the link action and continues the progression of the linkage as the gesture is performed. If the user aborts the gesture before it is completed, the device may abort the linkage, and/or reverse any linking that the device conducted. If the gesture is completed, the device may complete the linking process for the applications. For example, if the linking action uses a drag and drop system, where the user selects an icon by contacting the touchscreen and dragging the icon to another icon by swiping across the touchscreen while maintaining continuous contact with the touchscreen, and the user taps the touchscreen once, the device may begin the process of the state transition as soon as it detects the tap, but may abort the process soon after because the device determines that the tap does not correspond to the linking action.

In some embodiments, the device may display a linkage progress image, which may be shown along with visual cues. The linkage progress image may be a graphical, interactive user-interface object with which the user interacts in order to complete a linking gesture for linking one application with another. In some examples, the linking action is performed with respect to the linkage progress image. In some embodiments, performing the linking action with respect to the image includes dragging an icon for an application in a predefined manner, which progresses a status bar of a linking image. In some embodiments, if the linking action is not completed, the GUI display can show reverse progress.

In some embodiments, in addition to visual feedback, the device may supply non-visual feedback to indicate progress towards completion of the linking action. The non-visual feedback may include audible feedback (e.g., sound(s)) and/or physical/tactile feedback (e.g., vibration(s)).

In some embodiments, the device may display and/or indicate what applications are linked with each other. In some examples, the icon for a first application may be modified to include miniature icons for applications that are linked with the first application. In some examples, the graphical user interface of the application, when running, may display images, text, and/or other indicators that notify the user what applications are linked with the running application.

In some embodiments, gestures may be used to unlink applications. For example, a user may repeat a gesture, do a gesture in reverse, do a different gestures that is specific to unlinking and/or the like which may cause linked applications to unlink. In some embodiments, applications may be unlinked through a setting menu, a code, voice command and/or a series of inputs from the user. In some embodiments, processes discussed above may unlink one or more applications instead of linking an application.

FIG. 2A is a flow diagram illustrating a process 210 for linking two applications on a device, such as computer system 100 of FIG. 1, when a user provides an audio signal according to some embodiments. While process 210 described below includes a number of operations that appear to occur in a specific order, it should be apparent that these processes may include more or fewer operations, which may be executed serially or in parallel (e.g., using parallel processors and/or a multi-threading environment), combined, and/or in different orders.

At 211, a device may be running an application. The device may have a window open for the application, and/or the device may be displaying user interface for the application. In some embodiments, the device may be executing/running one or more processes for an application.

At 212, the user may create an audio signal. The audio signal may be a whistle, clap, snap, a musical note, a voice command, and/or any other audio signal.

At 213, the device may detect the audio signal. In some examples, the audio signal may be detected using a device that detects vibrations, such as a microphone. In some examples, a video capturing device may be used to detect the audio signal by capturing video of objects vibrating from the audio signal, such as a shirt, a leaf, and so forth. The vibrations detected by the video capturing device may be translated into a digital representation of the audio signal. One of ordinary skill in the art would recognize that there are many devices that may be used to detect audio signals, all of which are contemplated herein.

At 214, the device may determine whether the audio signal translates to an application link command to the device. In some embodiments, the device may have a voice user interface (VUI) that may apply speech recognition and/or voice recognition to isolate and/or detect relevant audio signals and/or voice commands. For example, a user may have created an audio signal by speaking the words “link to second application.” The device may recognize the user's voice and translate the voice command to a device command, such as an application link command. In some embodiments, the device may record the audio signal and send the audio signal to a third party-server and/or device over a network which translates the audio signal into one or more device commands and/or error messages. In some embodiments, the third-party server and/or device may return the translated device commands and/or error messages to the device over the network.

If the audio signal does not translate to an application link command for a second application, the device may not link the running application to the second application at 215.

If the audio signal does translate to an application link command for a second application, then the device may link the running application with the second application at 216. In some embodiments, the device may link the running application with the second application if the user identifies the second application in the voice command and the device detects the identification of the second application in the voice command. In some embodiments, a third party server and/or device may be used to detect the identification of the second application.

In some embodiments (not shown) audio signals may be picked up from the device to link applications that are not running. In some embodiments, applications may be linked by a voice command that identifies a first application and a second application. For example, the voice command “link [first application identifier] with [second application identifier]” may cause the device to link and/or attempt to link the first application with the second application. In some embodiments, an application identifier may be a name of the application.

In some embodiments, the audio signals discussed above may be user specific and/or user created. In some examples, the device may only accept voice commands from vocal signatures that are unique to one or more users. In some examples, the device may only accept voice commands when a third-party server and/or device determines that a voice command matches one or more unique vocal signatures. In some examples, the voice commands may be user created and/or user specific. For example, a use may configure the device such that a particular audio signal is translated to a user selected device command, such as linking applications.

In some embodiments, the device may also unlink applications with voice commands in a similar manner as when applications are linked. For example, a user may provide the voice command “unlink [first application identifier] and [second application identifier]” which may cause the first application to unlink from the second application. In some embodiments, the processes discussed above may unlink one or more applications instead of linking applications. In some embodiments, process 210 may be used to unlink applications.

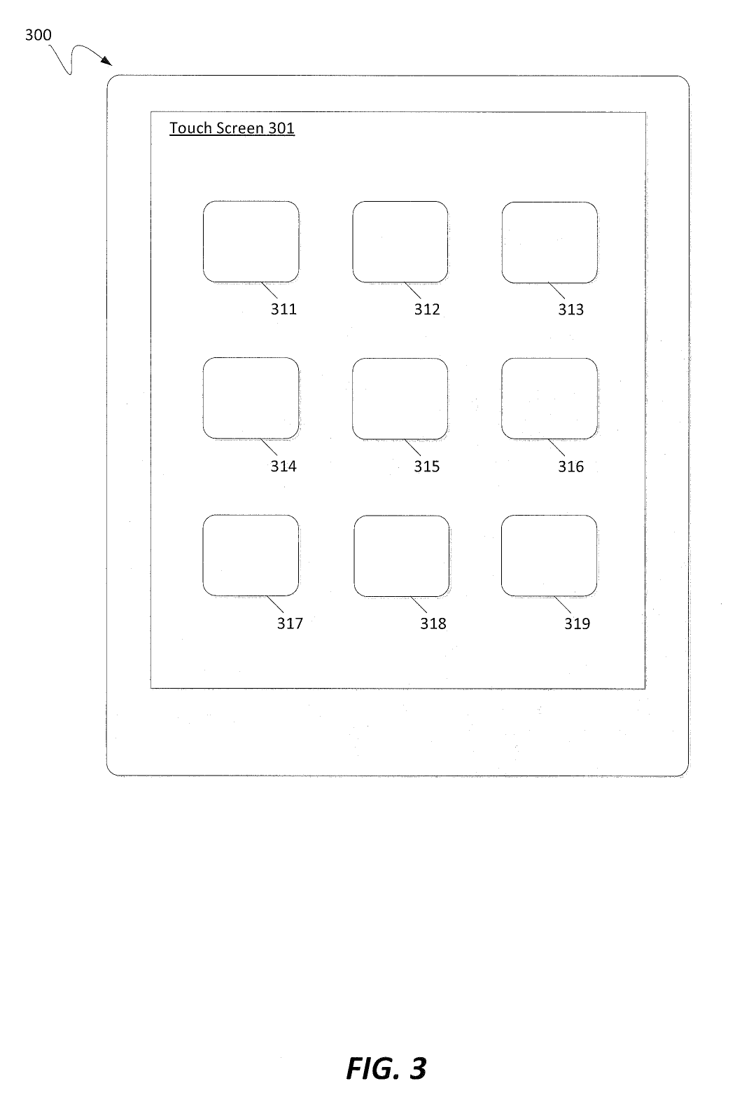

FIG. 3 is an exemplary GUI display used by a device 300 that may implement process 200 of FIG. 2. A user may use the GUI to perform a linking action to link applications, according to some embodiments. In some embodiments, user device 300 may be a computer system, such as computer system 100 of FIG. 1, with a touchscreen 301. Touchscreen 301 may display a home screen that is displaying several user-interface objects, such as icons 311-319. In some embodiments, one or more of icons 311-319 may be icons for one or more applications installed on user device 300. A user may be able to interact with icons 311-319 by making contact on a location of touchscreen 301 proximal to, center of, and/or near center of a displayed icon, such as icon 311. In some examples, a tap (e.g. touching and discontinuing the touch within a predetermined time limit) on the location of an icon, such as icon 311, may initiate the application that the icon is related to. In some examples, device 300 may conduct different actions based the length of time a user contacts touchscreen 301 on a location of an icon. In some examples by touching the touchscreen for a predetermined period of time, device 300 may provide the user the ability to move icons 311-319. In some examples, by touching touchscreen 301 for a predetermined period of time, such as three seconds or more, on the location of an icon, device 300 may detach the icon from the icons placement and allow a user to move the icon to another location through a gesture, such as a swiping across touchscreen 301.

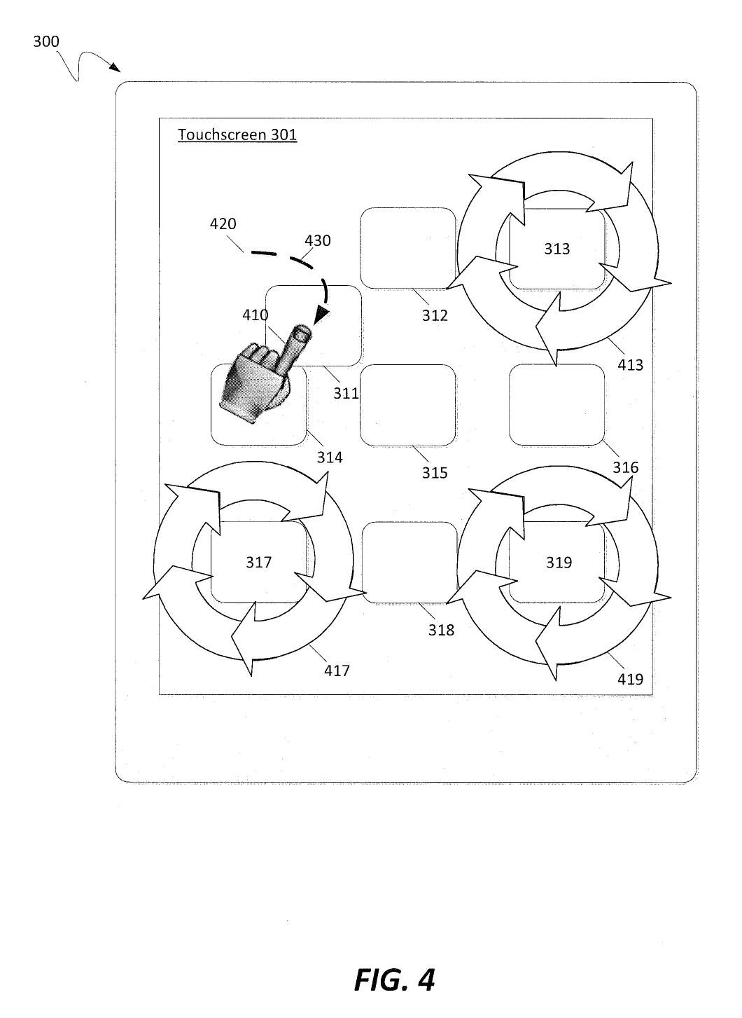

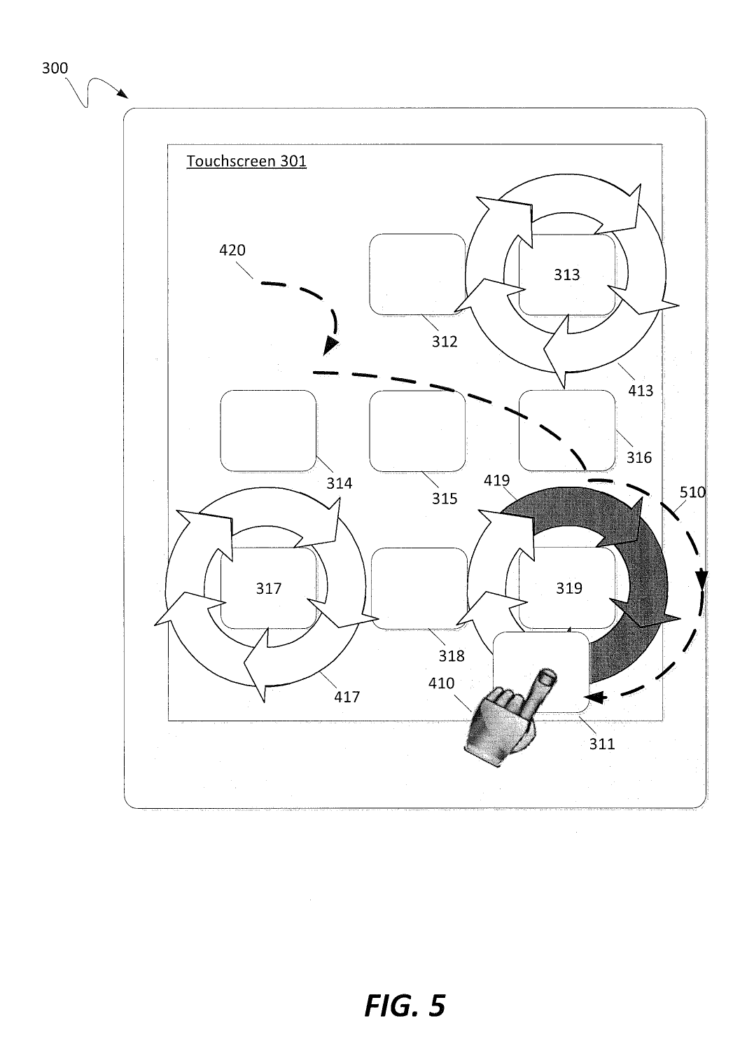

FIGS. 4-5 illustrate the GUI display of FIG. 3 at various points during the performance of a linking action on device 300 of FIG. 3, according to some embodiments. In some embodiments, the performance of a linking action may be the satisfaction of a user input condition.

In FIG. 4, a user, represented by finger 410, may have begun the linking action for the application represented by icon 311. In some embodiments, the user may have initiated the linking action by touching touchscreen 301 for a predetermined period of time at original location 420 of icon 311. The predetermined period of time may be a short period of time, such as a period of time under thirty seconds. In some embodiments, the user may touch touchscreen 301 for a predetermined period of time at original location 420 of icon 311, and in response, device 300 may have detached icon 311 from the user interface and allowed the user to move icon 311. The user may have moved icon 311 by swiping along touchscreen 301 with a continuous contact to touchscreen 301 along swipe path 430 with finger 410.

Although a finger is used in this example, the user may use a stylus or other devices to make contact with touchscreen 301. In some embodiments, finger 410 may be a virtual pointer that is controlled by a peripheral, such as a mouse or other point device, and clicking on a button on the peripheral may serve as the function of touching the touchscreen at the location of the virtual pointer.

In some embodiments, at various points during the performance of a linking action, device 300 may display visual cues indicating which applications can be linked, such as visual cues 413, 417, and 419. In some embodiments, the visual cues may be displayed after the user has selected an icon, such as icon 311, by continuously contacting touchscreen 301 at the location of the icon for a predetermined period of time. In some embodiments, device 300 may display visual cues once the user has begun moving an icon, such as icon 311, from its original location, such as original location 420. In some embodiments visual cues, such as visual cues 413, 417, and 419, may highlight applications that are linkable with the application of the moved and/or selected icon 311.

Although in this example, visual cues 413, 417, and 419 highlight icons 313, 317, and 319, respectively, by displaying a circle around the icons, one of ordinary skill in the art would recognize other methods of highlighting an icon, which are contemplated herein. Some methods of highlighting an icon may include, but are not limited to, causing the icon to blink, brighten, dim, shake; adding text to the icon; surrounding the icon with an image; and/or the like. In some embodiments, a highlight of an icon may also indicate a user input condition for linking applications, the user input condition may be one or more gestures.

In some examples, device 300 may indicate one or more user input conditions by displaying an image and/or an animation of a gesture path. In some examples, the image and/or animation of the gesture path may be an image and/or animation indicating a clockwise circular motion, as shown by the arrows of visual cues 413, 417, and 419. In some embodiments the gesture may be conducted by dragging the icon, such as icon 311, along the gesture path displayed by the image and/or animation of visual cue 419. The gesture path may be a clockwise circular motion around an icon such as icon 313, 317, and/or icon 319. In some embodiments, the gesture path may indicate which application will be linked once a gesture is complete. For example, when icon 311 is dragged along the path shown by visual cue 419, the application related to icon 311 may be linked with the application related to icon 319.

In FIG. 5, the user may have continued the progression of completing the linking action in FIG. 4, according to some embodiments. In some examples the user may have conducted a gesture illustrated by swipe path 510. The gesture may have been a continuous swipe conducted on touchscreen 301 along the dotted line illustrated by swipe path 510. In some embodiments, the user's gesture may have dragged icon 311 along swipe path 510.

In some embodiments, device 300 may aid the user in dragging icon 311 along visual cue 419 by snapping icon 311 onto the path created by visual cue 419 when the user drags icon 311 close to visual cue 419. In this sense, device 300 conducts a predictive action for the user's intention to conduct a linking action.

In some embodiments, visual cue 419 may also act as a status bar indicating the completion progress of the user input condition. The image may darken or change colors to indicate the input progress, as shown by the darkened portions of visual cue 419. The completion progress may track the user's gesture when the user's gesture corresponds to and/or follows the indications of visual cue 419. In some embodiments, the user may reverse the completion processes by back tracking swipe path 510 and/or abandoning the gesture. For example, if a clockwise drag of an icon causes the completion status to increase, a counterclockwise gesture may decrease the completion status. In some embodiments, when the status bar is fully completed, device 300 may initiate and/or complete the linking processes (e.g. process 207) between the applications related to icons 311 and 319.

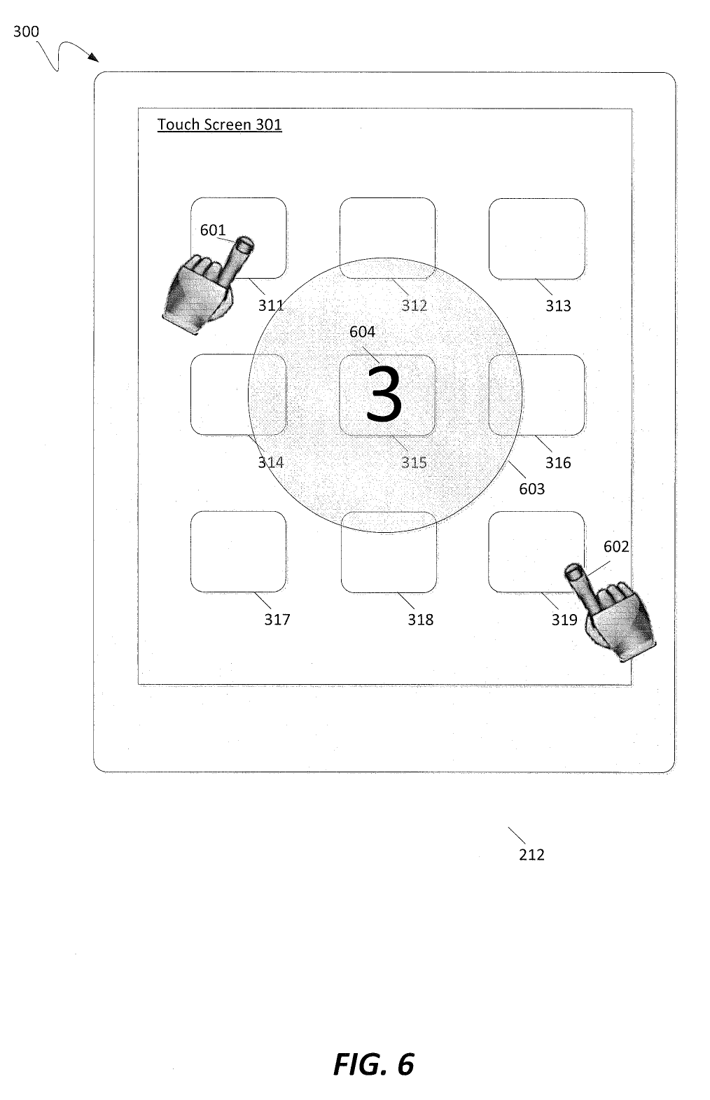

FIG. 6 illustrates another user input condition that a user may conduct as a linking action on the GUI display of user device 300 of FIG. 3, according to some embodiments. In some embodiments, device 300 may be able to process multiple contact points of touchscreen 301; this may be referred to as multi-touch capable touchscreen. A user may activate the linkage between two applications through multi-touch actions. In some examples, the multi-touch action may be touching the locations of the icons which represent the applications the user wishes to link. As shown in FIG. 6, the user may have conducted a first contact with finger 601 on touchscreen 301 at the location of icon 311, and concurrently and/or at the same time conducted a second contact with finger 602 on icon 319. In some embodiments, the user condition may be satisfied when a user touches the icons for a predetermined amount of time. Device 300 may display an indicator 603, indicating the length of time left for a condition to be completed. Indicator 603 may have a countdown 604 that counts down the time until device 300 links the applications. The predetermined amount of time may be a short period of time under 30 seconds, such as three seconds. In some embodiments, the device may supply non-visual feedback to indicate progress towards satisfaction of the user input condition. The non-visual feedback may include audible feedback (e.g., sound(s)) or physical/tactile feedback (e.g., vibration(s)).

Although exemplary user input conditions for a linking action are shown in FIGS. 4-6, these are meant to be exemplary and not exhaustive. Device 300 may use other user actions, gestures, and/or combinations of actions and/or gestures as a user input condition. Some user input conditions may include, but are not limited to, a drag and drop system, where an icon for an application is dragged and dropped on top of an icon for another application that the user wants to link; a gesture that corresponds to one or more letters in an alphabet; a gesture for another shape, such as a square or triangle, the dragging of two icons together using a multi-touch capable touchscreen; and/or the like.

Additionally, although the examples provided above show methods of linking applications from the home screen, applications may be link from within the user interface of an application. In some examples, a user may input a gesture, such as swiping the letter P, while running a merchant application which links the merchant application with the application related to the P gesture, such as a payment application.

In some embodiments, multiple gestures may be used to link applications, and different gestures may cause the device to conduct a different linking action. For example a payment application may have multiple credit cards associated with the payment application. Certain gestures may link the payment application with a merchant application in a manner that allows a user to make purchases from the merchant application with the payment application without the user having to provide payment information. Different gestures may cause the payment application to use different credit cards and/or other payment instruments to conduct a purchase through the merchant application. For example, tracing the number 1 may link a first credit card from the payment application with the merchant application, and tracing the number 2 may link a second card from the payment application with the merchant application. In some embodiments, when an application is linked with another application, a menu may be displayed which may provide linking options, such as which credit cards may be linked, what information may be transferred, and so forth.

In some embodiments, application linking may share different information, plugins, data access, and/or application permissions based on the applications being linked. For example, a payment application may provide payment account information to a merchant application for music services, but provide payment account information and addresses for merchant applications for tangible goods. In some embodiments, applications may segregate data for a particularly linked application. For example, the application may have different promotions for different linked applications, and the promotion may only be sent to a particular linked application. In some examples, a payment application may track loyalty data for different linked application, and the payment application may limit access to the loyalty data to only the loyalty data related to the linked application.

In some embodiments, different linking actions may set the level of data shared between applications. The levels of data may be categorized, such as, innocuous, payment, and/or personal. In some examples, the innocuous level may allow sharing and/or transfer of anonymous information, such as browsing data; the payment level may allow sharing and/or transfer of monetary funds from an account in addition to everything within the innocuous level; and the personal level may allow sharing and/or transfer of identification information, such as a name, address, and/or the like in addition to everything within the payment level. In some embodiments, the information shared at each level may be altered by the user.

In some embodiments, a gesture may determine the data access level for the linked application. In some examples, the data access level may be determined by how many times a predetermined gesture is repeated. For example, one circular gesture may indicate a first level, such as the innocuous level; two circular gestures may indicate a second level, such as the payment level; and three circular gestures may indicate a third level; such as the personal level. In some embodiments, by conducting one or more reverse circle or one or more additional circles, the applications may reduce data access levels and/or unlink the applications. Different embodiments may have more or less categories and/or levels of data sharing and may have different gestures.

In some embodiments, the device, application, and/or linked application may automatically determine what information the application needs from the linked application and facilitate the permission to transfer and/or transfer the information between the application and linked application. For example, a merchant application may request information such as a username, password, address, and/or the like. The merchant application may request the information from a user by providing designated data fields for the information. In some examples, the device and/or linked application may detect the data request and automatically populate the data fields on behalf of the user from the linked application, such as a payment application.

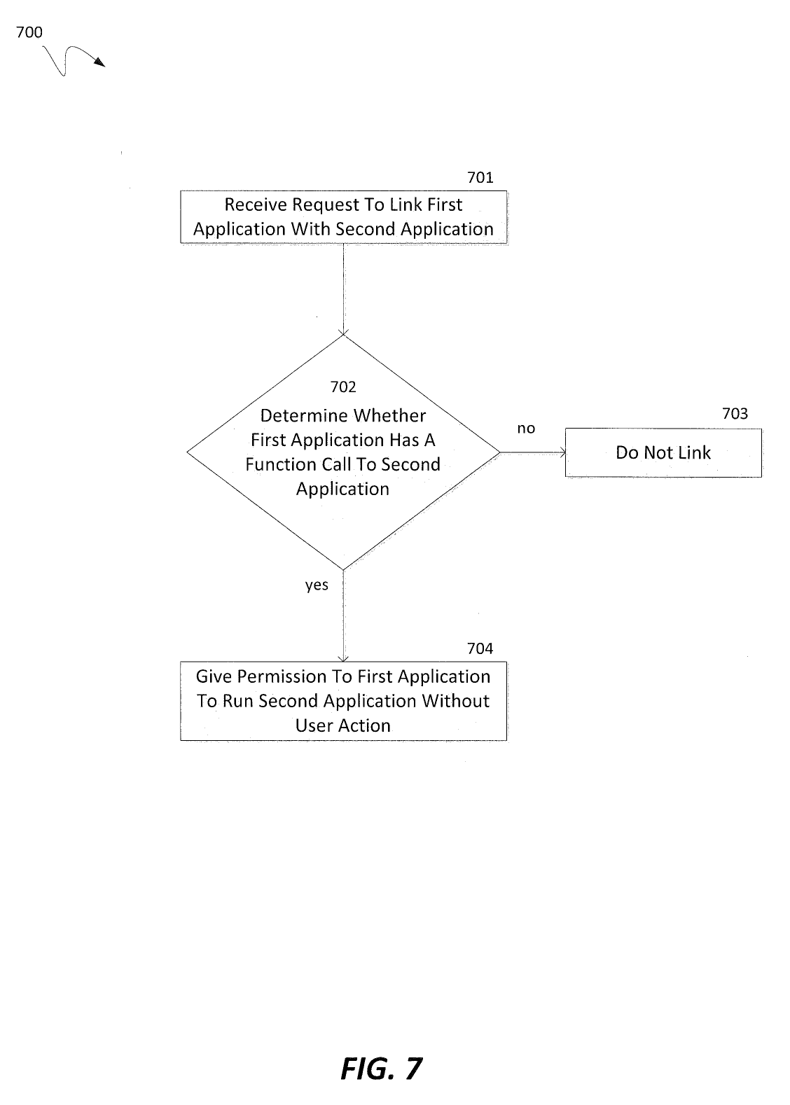

FIG. 7 illustrates a flow diagram of an exemplary process 700 of linking applications on a device, such as user device 300 of FIG. 3, according to some embodiments. While process 700 described below includes a number of operations that appear to occur in a specific order, it should be apparent that these processes may include more or fewer operations, which may be executed serially or in parallel (e.g., using parallel processors or a multi-threading environment), and in different orders. At 701, the device may receive a request to link a first application with a second application. The request may be in the form of and/or in response to the completion of a user input condition. The user input condition may be a combination of user actions and gestures, such as the user actions and gestures described above in relation to FIGS. 4-6.

At 702, the device may determine whether the first application includes the ability to link with the second application. In some embodiments, the device may check for a function call to the second application. In some embodiments, the device may determine whether the first application includes a function call to the second application and/or whether the second application includes a function call to the first application from a list provided by the first and/or second application. The list may include every application that the first and/or second application is capable of linking with. The list may be updated when an application is installed and/or executed on the device.

In some embodiments, applications may provide a library of functions and/or application programming interfaces (APIs). In some examples, the device may determine whether the first application uses or calls any of the functions and/or APIs of the second application by inspecting the library of the second application. In some examples, the device may determine whether the second application uses or calls any of the functions and/or APIs of the first application by inspecting the library of the first application.

If the first application does not include any function calls to the second application (and/or vice versa), the device may deny the linking request at 703. In some embodiments, the device may return and error message and/or provide an indication that the applications did not link.

If the first application does include a function call to the second application (and/or vice versa), the device may allow and/or give permission to the first application to automatically run part and/or all of the functions of the second application, at 704. In some embodiments, when the first and second applications are linked, the first application may be able to run and/or execute the second application without additional user action and/or input. In some embodiments, when the first and second applications are linked, the device may allow the first application to communicate and/or transfer data with the second application.

Although the examples described above describe linking and detection of linkability between a first application and a second application from the perspective of the first application, one or ordinary skill in the art would recognize that linking and detecting linkability may also be conducted from the perspective of the second application. Linking may also be possible between more than two applications.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums, such as system memory component 114 and/or static storage component 116. It is also contemplated that software identified herein may be implemented using one or more general purpose or specific purpose computers and/or computer systems, networked and/or otherwise, such as computer system 100. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A device comprising:
a touchscreen display; and
a processor configured to:
display a first representation for a first application at a first location on the touchscreen display and a second representation for a second application on the touchscreen display;
detect a contact on the touchscreen display at the first location;
detect a gesture on the touchscreen display; and
link the first application with the second application when the gesture conforms with a predetermined gesture.

2. The device of claim 1, wherein the processor is further configure to detect the gesture on the touchscreen display when the contact on the touchscreen display is for a predetermined amount of time.

3. The device of claim 2, wherein the processor is further configured to display an image indicating that the second application can be linked with the first application.

4. The device of claim 3, wherein the image further provides instruction on how to perform the predetermined gesture.

5. The device of claim 3, wherein the image is a status bar that displays a progress of the gesture conforming to the predetermined gesture, the predetermined gesture being a circular motion around the second representation.

6. The device of claim 1, wherein linking the first application with the second application comprises exchanging data between the first application and second application.

7. The device of claim 6, wherein linking the first application with the second application further comprises providing the first application pet to populate data fields in the second application.

8. A method of linking a first application and a second application on a device, the device including a touchscreen display, the method comprising:
displaying a first representation for a first application at a first location on the touchscreen display and a second representation for a second application on the touchscreen display;
detecting a contact on the touchscreen display at the first location;
detecting a gesture on the touchscreen display that conforms with a predetermined gesture; and
linking the first application with the second application in response to detecting the gesture on the touchscreen display.

9. The method of claim 8, wherein the predetermined gesture determines a first data access level for the second application.

10. The method of claim 9, wherein repeating the predetermined gesture changes the first data access level to a second data access level.

11. The method of claim 10, wherein linking the first application with the second application comprises exchanging data between the first and second application in accordance with the second data access level.

12. The method of claim 8, wherein detecting the contact on the touchscreen display includes detecting the contact for a predetermined amount of time.

13. The method of claim 12, wherein the method further comprises displaying an object indicating that the second application can be linked to the first application in response to detecting the contact for a predetermined amount of time.

14. The method of claim 12, wherein displaying the object provides instructions on how to perform the predetermined gesture.

15. A machine readable memory storing instructions, which when executed by a device with a touchscreen causes the device to perform a method comprising:
displaying a first representation for a first application at a first location on the touchscreen display and a second representation for a second application on the touchscreen display;
detecting a contact on the touchscreen display at the first location;
detecting a gesture on the touchscreen display that conforms with a predetermined gesture; and
linking the first application with the second application in response to detecting the gesture on the touchscreen display.

16. The machine readable memory of claim 15, wherein detecting the contact on the touchscreen display includes detecting the contact for a predetermined amount of time.

17. The machine readable memory of claim 16, wherein the method further comprises displaying an object indicating that the second application can be linked to the first application.

18. The machine readable memory of claim 17, wherein displaying the object provides instructions on how to perform the predetermined gesture.

19. The machine readable memory of claim 18, wherein the object is a status bar displaying the progress of the gesture conforming to the predetermined gesture.

20. The machine readable memory of claim 15, wherein linking the first application with the second application comprises exchanging data between the first and second application.
